(19) United States
(12) Patent Application Publication
(10) Pub. No.: US 2024/0375177 A1
(43) Pub. Date: Nov. 14, 2024

(54) VACUUM DISTILLATION FURNACE, AND METHOD FOR PREPARING HIGH-PURITY COPPER PARTICLES

(71) Applicant: KUNMING UNIVERSITY OF SCIENCE AND TECHNOLOGY, Kunming, Yunnan (CN)

(72) Inventors: Yang TIAN, Kunming, Yunnan (CN); Dong WANG, Kunming, Yunnan (CN); Haosong YU, Kunming, Yunnan (CN); Bin YANG, Kunming, Yunnan (CN); Baoqiang XU, Kunming, Yunnan (CN); Wenlong JIANG, Kunming, Yunnan (CN); Yifu LI, Kunming, Yunnan (CN); Fei WANG, Kunming, Yunnan (CN); Dong LIANG, Kunming, Yunnan (CN); Shuangping WANG, Kunming, Yunnan (CN); Qingsong LI, Kunming, Yunnan (CN)

(21) Appl. No.: 18/681,366

(22) PCT Filed: Jun. 20, 2023
(86) PCT No.: PCT/CN2023/101272

§ 371 Date: Feb. 5, 2024

(30) Foreign Application Priority Data
May 9, 2023 (CN) 202310517685.6

(51) Int. Cl. B22F 9/12; B01D 3/10; B22F 1/05

(52) U.S. Cl. CPC B22F 9/12; B01D 3/10; B22F 1/05; B22F 2301/10; B22F 2304/10; B22F 2998/10

(57) ABSTRACT

Provided are a vacuum distillation furnace, and a method for preparing high-purity copper particles. In view of the fact that high-purity copper prepared by the traditional method in the current industrial production has an unsatisfactory purity, a high impurity content, and a complicated composition, a vacuum distillation method is adopted. During the vacuum distillation method, most of valuable metals in a copper matrix are volatilized and enter into a gas phase, such that the metals are separated from the copper matrix, thereby allowing the purification of copper; and copper powder particles volatilized to a condensation plate have a smooth surface and a purity of 5 N grade or more.

The present application claims priority of Chinese Patent Application No. 202310517685.6 filed with the China National Intellectual Property Administration (CNIPA) on May 9, 2023 and entitled “VACUUM DISTILLATION FURNACE, AND METHOD FOR PREPARING HIGH-PURITY COPPER PARTICLES”. The disclosure is incorporated herein by reference in its entirety.

### TECHNICAL FIELD

The present disclosure relates to the technical field of preparation of high-purity metals, and in particular to a vacuum distillation furnace, and a method for preparing high-purity copper particles.

### BACKGROUND

In the existing industrial production, metallic copper is capable of maintaining strong competitiveness in the metal materials market for its prominent ductility, thermal conductivity, and electrical conductivity. High-purity copper refers to metallic copper with a purity of 99.999% (5N) or more, and in terms of purity, high-purity copper products mainly include 99.999% (5N)-grade high-purity copper, 99.9999% (6N)-grade high-purity copper, 99.99999% (7N)-grade high-purity copper, and the like. Copper powders usually refer to fine copper granular powders with a particle size of 1 μm or less, and are widely and commonly used in fields such as powder metallurgy, diamond tools, sealing materials, electrical copper powder thermally-conductive materials, electrically-conductive materials, welding materials, superhard materials, friction materials, and pharmaceutical chemicals. With the rapid development of high-grade, high-precision, and advanced technical fields in recent years, the consumption of high-purity copper with different particle sizes is increasingly high.

At present, various production methods for high-purity copper powders mainly have the following characteristics:
(1) Electrolysis method: The electrolysis method is simple and low-cost, but has high requirements for purification of an electrolysis solution produced after electrolysis, because during the electrolysis, a large amounts of waste acids would be produced. In addition, it is difficult to arrive at a purity required by metallic copper as a catalyst material by the traditional electrolysis method. Because in the treatment of a copper raw material including a variety of impurities, impurity elements are difficult to be efficiently separated; thus, the purity of a product is difficult to be ensured. For example, a patent No. CN101011747A discloses that a filler copper powder is prepared with electrolytic cuprous oxide as a starting material at low cost, where the filler copper powder has an average particle size of 1 μm or less and preferably 0.5 μm or less with excellent particle size consistency, and is suitable for electrically-conductive pastes. The above method is as follows: in the presence of a protective colloid, the cuprous oxide is mixed with a reducing agent in water including a water-soluble copper salt to obtain the filler copper powder; or, a water-soluble copper salt is reduced in water including a protective colloid to produce a slurry, and then in the presence of the slurry, the cuprous oxide is reduced to obtain the filler copper powder. In this patent, a copper powder with an average particle size of 0.3 μm is successfully prepared, but the method requires a large consumption of solutions.
(2) Atomization method: In the atomization method, a metal or an alloy melted at a high temperature and a high pressure is generally crushed with a high-pressure gas, a high-pressure liquid, or a blade rotating at a high rotational speed to produce fine liquid droplets, and then the fine liquid droplets are condensed in a collector to obtain an ultrafine metal powder. The above atomization method does not involve a chemical change, and is commonly used in the production of metal powders such as Fe, Sn, Zn, Pb, and Cu powders. Atomized powders have advantages such as high sphericity, controllable powder particle size, low oxygen content, low production cost, and adaptation to production of various metal powders. The atomization method has become a main development direction of preparation of high-performance and special alloy powders. However, the atomization method has defects such as low production efficiency, low ultrafine powder yield, and relatively-large energy consumption. For example, a granted patent No. CN1286604C discloses a method for producing a copper powder through water atomization, including: using a ring-hole nozzle with a nozzle aperture of 1.6 mm to 1.8 mm to conduct atomization with a jet apex angle of 35° to 45°, an atomized water pressure of 12 MPa to 19 MPa, and a molten metal temperature of 1,160° C. to 1,200° C. to obtain a wet powder with a Poisson's ratio of 2.5 g/cm³ to 2.9 g/cm³, and then subjecting the wet powder to dehydrating, reduction-sintering, crushing, and sieving to obtain the copper powder. This method could directly lead to a copper powder with a low Poisson's ratio without drying and oxidation procedures. However, in this method, there are specified operation risks in the process of preparing the copper powder under high-temperature and high-pressure conditions, and the copper powder further needs to be sintered, which makes the copper powder easy to be oxidized; thereby reducing the purity of the copper powder.
(3) Vacuum distillation refining method: Vacuum distillation is conducted under reduced pressure and is generally used to separate substances that are easily decomposed when heated to a boiling point under ambient pressure. The vacuum distillation is also used for deep purification of some special gases, and is another common method for purifying high-purity metals. However, if a copper powder with a specified particle size needs to be prepared during the purification of copper, a traditional device could only allow purification, but cannot allow granulation. A patent No. CN113897501A discloses a method for purifying metallic manganese through vacuum distillation, including: heating a manganese raw material under vacuum, and collecting a distilled manganese vapor by a condensation device and condensing to obtain the metallic manganese. This method could purify a commercially-available manganese raw material to obtain a metallic manganese with a purity of 4 N to 5 N, a total impurity content of lower than 50 ppm and a total gas element impurity content of lower than 100 ppm, and a number of non-metallic insoluble inclusions with a particle size of larger than 1.3 μm per 1 g of the metallic manganese is smaller than 5,000, which meet the requirements of semiconductor target raw materials. In addition, the method disclosed in CN113897501A has advantages such as simple process, low energy consumption, and small environmental pollution. However, the method disclosed in CN113897501A could merely purify the metal, but hardly lead to metal particles meeting use requirements.

### SUMMARY

An object of the present disclosure is to provide a vacuum distillation furnace, and a method for preparing high-purity copper particles. The method of the present disclosure could directly lead to high-purity copper particles with a particle size of 1 μm to 100 μm and a purity of 5 N-grade or more. In addition, the method of the present disclosure shortens a process flow, does not require a treatment of a waste liquid, and has the characteristics of low cost and no pollution.

To achieve the object of the present disclosure, the present disclosure provides the following technical solutions:

Provided is a vacuum distillation furnace, where an evaporation orifice plate is provided between a condensation plate and an evaporation chamber; and the evaporation orifice plate has a pore size of 1 mm to 10 mm.

In some embodiments, the evaporation orifice plate has a porosity of 0.138% to 13.80%.

In some embodiments, the evaporation orifice plate has a shape of a conical disc.

In some embodiments, the evaporation orifice plate is a chromium plate.

Also provided is a method for preparing high-purity copper particles, including the following steps: placing a metallic copper raw material in the evaporation chamber of the vacuum distillation furnace described in the above solution; and subjecting the metallic copper raw material to vacuum distillation to obtain the high-purity copper particles on the condensation plate; where the vacuum distillation is conducted at a vacuum degree of 0.1 Pa to 100 Pa and a temperature of 1,100° C. to 1,800° C.; and the high-purity copper particles have a particle size of 1 μm to 100 μm.

In some embodiments, the vacuum distillation is conducted for 0.5 h to 3 h.

In some embodiments, the metallic copper raw material is heated to the temperature for the vacuum distillation at a heating rate of 5° C./min to 20° C./min.

In some embodiments, the metallic copper raw material includes an electrolytic cathode copper.

In the present disclosure, a vacuum distillation furnace is provided, where an evaporation orifice plate is provided between a condensation plate and an evaporation chamber; and the evaporation orifice plate has a pore size of 1 mm to 10 mm.

According to a principle of gas atomization, the higher the pressure of a compressed gas, the greater the flow rate; and the larger the amount of an atomized gas released per unit time, the smaller the particles. Compared with an vacuum distillation furnace without the evaporation orifice plate, providing the evaporation orifice plate in the present disclosure makes a gas channel narrowed and a gas flow rate increased when a vapor at high temperature passes through the evaporation orifice plate, which allows reduced particles and an increased powder amount. The vacuum distillation furnace of the present disclosure has a granulation function while purifying copper to obtain copper powder particles with a specified particle size.

In view of the fact that high-purity copper prepared by the traditional method in the current industrial production has an unsatisfactory purity, a high impurity content, and a complicated composition, a vacuum distillation method is adopted in the present disclosure. During the vacuum distillation method, most of valuable metals in a copper matrix are volatilized and enter into a gas phase, such that the metals are separated from the copper matrix, thereby allowing the purification of copper; and copper powder particles volatilized to the condensation plate have a smooth surface and a purity of 5 N grade or more, and thus could be used in fields such as catalyst doping and medical chemical industry.

In the method of the present disclosure, through vacuum distillation, a high-purity copper condensate with a purity of 5 N grade or more could be obtained with copper powder particles enriched and collected. The method of the present disclosure shortens a process flow, does not require a treatment of a waste liquid, and has characteristics of low cost and no pollution.

### BRIEF DESCRIPTION OF THE DRAWINGS

FIG. 1 shows a schematic structural diagram of the vacuum distillation furnace of the present disclosure, where 1 refers to a sealing ring; 2 refers to a handle; 3 refers to a sealing screw; 4 refers to a furnace cover; 5 refers to a furnace shell; 6 refers to an air extraction hole; 7 refers to a crucible; 8 refers to a heating element; 9 refers to a thermocouple; 10 refers to an insulation cotton; 11 refers to an electrode; 12 refers to a graphite hard felt; 13 refers to a water inlet and cooling water; 14 refers to a protective shell; 15 refers to an evaporation orifice plate; 16 refers to a condensation plate; and 17 refers to a gas cylinder;

FIG. 2 shows a flow chart of the method for preparing the high-purity copper particles according to an embodiment of the present disclosure;

FIG. 3 shows a top view of the high-purity copper condensate product prepared through vacuum distillation in Example 1;

FIG. 4 shows a top view of the high-purity copper particle volatile prepared through vacuum distillation in Example 1;

FIG. 5 shows a top view of the high-purity copper condensate product prepared through vacuum distillation in Example 2;

FIG. 6 shows a top view of the high-purity copper particle volatile prepared through vacuum distillation in Example 2;

FIG. 7 shows a top view of the high-purity copper condensate product prepared through vacuum distillation in Example 3;

FIG. 8 shows a top view of the high-purity copper particle volatile prepared through vacuum distillation in Example 3;

FIG. 9 shows a test report of the high-purity copper condensate product prepared through vacuum distillation in Example 3;

FIG. 10 shows a test report of the high-purity copper particle volatile prepared through vacuum distillation in Example 3;

FIG. 11 shows a scanning electron microscopy (SEM) image of the high-purity copper particles prepared through vacuum distillation in Example 1; and

FIG. 12 shows an SEM image of the high-purity copper particles prepared through vacuum distillation in Example 3.

### DETAILED DESCRIPTION OF THE EMBODIMENTS

The present disclosure provides a vacuum distillation furnace, where an evaporation orifice plate is provided between a condensation plate and an evaporation chamber; and the evaporation orifice plate has a pore size of 1 mm to 10 mm.

In some embodiments, the evaporation orifice plate has a pore size of 2 mm to 9 mm, preferably 3 mm to 8 mm, and more preferably 4 mm to 6 mm. In the present disclosure, the control of the pore size of the evaporation orifice plate in the above range makes it possible to not only prevent a pore size from being too small to cause impurity blockage, but also ensure a high gas flow rate, thereby ensuring an amount of a granular copper powder produced and obtaining copper particles.

In some embodiments, the evaporation orifice plate has a porosity of 0.138% to 13.80%, preferably 1% to 10%, and more preferably 2% to 8%. In a specific embodiment of the present disclosure, the evaporation orifice plate has a porosity of 2.2%.

In some embodiments, volatilization pores in the evaporation orifice plate are sequentially distributed in a number of 1², 2², 3², 4², 5² . . . n² from a center of the evaporation orifice plate to an edge of the evaporation orifice plate.

In some embodiments, the evaporation orifice plate has a shape of a conical disc, and a vertex of the conical disc is above a bottom surface of the conical disc; and a vertical distance between a lowest point and a highest point of the evaporation orifice plate (namely, a height of the evaporation orifice plate) is in a range of 5 cm to 10 cm. In the present disclosure, there is no special requirements for a diameter of the evaporation orifice plate, as long as the evaporation orifice plate could cover the evaporation chamber. There is no special requirements for a fixing manner of the evaporation orifice plate, as long as the evaporation orifice plate could be fixed, for example, a dimensional tolerance clearance fit could be adopted for the fixing.

In some embodiments, the evaporation orifice plate is a chromium plate. The present disclosure adopts an evaporation orifice plate of chromium. Metallic chromium has a melting point of 1,907° C., and thus the evaporation orifice plate is resistant to high temperature. More importantly, during volatilization of impurity elements, chromium could effectively react with impurity elements such as Fe, Si, Mn, Al, and Cl at a high temperature to adsorb these impurity elements on a lower surface of the evaporation orifice plate (according to a saturated vapor pressure, most of the above impurity elements are still gaseous in a given temperature range, have a relatively-large activation energy, and will undergo a chemical reaction at a high temperature, and a small part of copper will also be condensed in the given temperature range; and given a difference of a molecular free path between the impurity elements and the copper, the impurity elements are mostly condensed on the lower surface, and a copper vapor will enter an upper condensation zone through the evaporation orifice plate in large quantities and will be condensed into a copper particle), thereby allowing the separation of the impurity elements from the copper. Because the condensation plate is in direct contact with a cooling water system, when passing through the evaporation orifice plate and colliding with the condensation plate, the copper vapor will be quickly condensed into copper powder particles and collected on the condensation plate above the evaporation orifice plate.

In the present disclosure, the evaporation orifice plate is located below the condensation plate; and in an embodiment of the present disclosure, the highest point of the evaporation orifice plate is located at ½ of a zone between the evaporation chamber and the condensation plate.

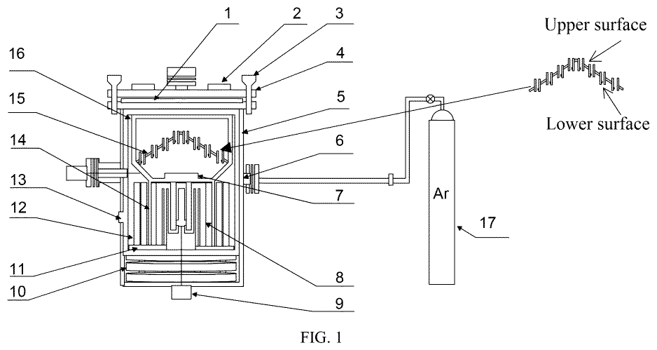

In the present disclosure, other structures of the vacuum distillation furnace are well-known structures in the art, and there is no special limitation in the present disclosure. As shown in FIG. 1, the vacuum distillation furnace provided in the present disclosure includes a sealing ring 1, a handle 2, a sealing screw 3, a furnace cover 4, a furnace shell 5, an air extraction hole 6, a crucible 7, a heating element 8, a thermocouple 9, an insulation cotton 10, an electrode 11, a graphite hard felt 12, a water inlet and cooling water 13; a protective shell 14, an evaporation orifice plate 15, a condensation plate 16, and a gas cylinder 17, where the crucible is located in the evaporation chamber.

The vacuum distillation furnace provided in the present disclosure does not produce a waste liquid and a waste gas, and has the characteristics of low cost and no pollution.

The present disclosure also provides a method for preparing high-purity copper particles, including the following steps: a metallic copper raw material is added into the evaporation chamber of the vacuum distillation furnace described in the above solutions, and the metallic copper raw material is subjected to vacuum distillation to obtain the high-purity copper particles on the condensation plate; where the vacuum distillation is conducted at a vacuum degree of 0.1 Pa to 100 Pa and a temperature of 1,100° C. to 1,800° C.; and the high-purity copper particles have a particle size of 1 μm to 100 μm.

In the present disclosure, there is no special requirements on a source and purity of the metallic copper raw material; and in an embodiment of the present disclosure, the metallic copper raw material includes an electrolytic cathode copper with a purity of 3 N grade.

In some embodiments, before the vacuum distillation, a surface of the metallic copper raw material is cleaned to remove oil stains. There is no special requirements on a method for cleaning the surface to remove oil stains, and a cleaning method well known in the art could be adopted. In an embodiment of the present disclosure, the metallic copper raw material is cleaned in absolute ethanol, and then naturally air-dried in a clean room.

In some embodiments, the vacuum distillation is conducted at a vacuum degree of 1 Pa to 95 Pa, preferably 5 Pa to 90 Pa, and more preferably 10 Pa to 80 Pa; the vacuum distillation is conducted at a temperature of 1,200° C. to 1,700° C., preferably 1,300° C. to 1,600° C., and more preferably 1,400° C. to 1,500° C.; and the vacuum distillation is conducted for 0.5 h to 3 h, preferably 1 h to 2.5 h, and more preferably 1.5 h to 2 h.

In some embodiments, the metallic copper raw material is heated to the temperature for the vacuum distillation at a heating rate of 5° C./min to 20° C./min and preferably 10° C./min to 15° C./min.

In some embodiments, after the vacuum distillation, a resulting product is cooled naturally to ambient temperature under vacuum, and then the high-purity copper particles are collected on the condensation plate.

In the present disclosure, the high-purity copper particles have a particle size of 1 μm to 100 μm, preferably 10 μm to 90 μm, and more preferably 20 μm to 80 μm. In some embodiments, the high-purity copper particles have a purity of 5N grade or more.

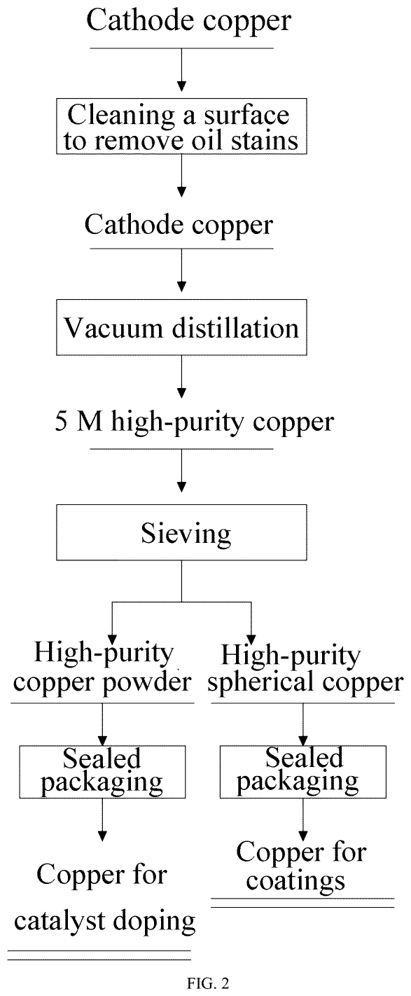

FIG. 2 shows a flow chart of the method for preparing the high-purity copper particles of the present disclosure. As shown in FIG. 2, in the method of the present disclosure, a surface of a metallic copper raw material is first cleaned to remove oil stains to obtain a cleaned metallic copper raw material, the cleaned metallic copper raw material is placed in the evaporation chamber of the vacuum distillation furnace, and then the cleaned metallic copper raw material is subjected to vacuum distillation to obtain high-purity copper particles on the condensation plate. In the present disclosure, the high-purity copper particles could be sieved according to practical applications to obtain a high-purity copper powder (which could be used for catalyst doping) and high-purity spherical copper (which could be used for coatings).

In view of the fact that high-purity copper prepared by the traditional method in the current industrial production has an unsatisfactory purity, a high impurity content, and a complicated composition, a vacuum distillation method is adopted in the present disclosure. During the vacuum distillation method, most of valuable metals in a copper matrix are volatilized and enter into a gas phase, such that the metals are separated from the copper matrix, thereby allowing the purification of copper; and copper powder particles volatilized to the condensation plate has a smooth surface and a purity of 5 N grade or more, which could be used in fields such as catalyst doping and medical chemical industry.

In the method of the present disclosure, through vacuum distillation, a high-purity copper condensate with a purity of 5 N grade or more could be obtained with copper powder particles enriched and collected. The method shortens a process flow, does not require a treatment of a waste liquid, and has characteristics of low cost and no pollution.

The vacuum distillation furnace and the method for preparing the high-purity copper particles provided by the present disclosure are described in detail below in conjunction with examples, but these examples should not be construed as limiting the scope of the present disclosure.

The vacuum distillation furnace used in the following examples is shown in FIG. 1, where the highest point of the evaporation orifice plate is located at ½ of a zone between the condensation plate and the evaporation chamber. The evaporation orifice plate is made of chromium, and the evaporation orifice plate is a conical disk. A vertical distance between the lowest point and the highest point of the evaporation orifice plate is 10 cm. The evaporation orifice plate has a porosity of 2.2% and a pore size of 4 mm. Volatilization pores in the evaporation orifice plate are sequentially distributed in a number of 1², 2², 3², 4², and 5² from a center of the evaporation orifice plate to an edge of the evaporation orifice plate, with 55 pores in total.

### Example 1

(1) 10.56 g of 3 N-grade electrolytic cathode copper was cleaned with absolute ethanol, and then air-dried naturally in a clean room, and then added into a vacuum distillation furnace. The vacuum distillation furnace was vacuumed to maintain a gas pressure in the vacuum distillation furnace at 10 Pa. The electrolytic cathode copper was heated uniformly to 1,400° C. at a heating rate of 10° C./min, and then subjected to vacuum distillation for 120 min such that volatile impurity elements such as Al, Cd, Bi, Ga, K, Mg, Zn, Pb, Ga, Fe, Ni, Si, and Au volatilized to a lower surface of the evaporation orifice plate. Then, the vacuum distillation furnace was cooled with circulation water under vacuum to ambient temperature, such that a high-purity copper condensate was obtained in a crucible and high-purity copper particles were collected on the condensation plate.

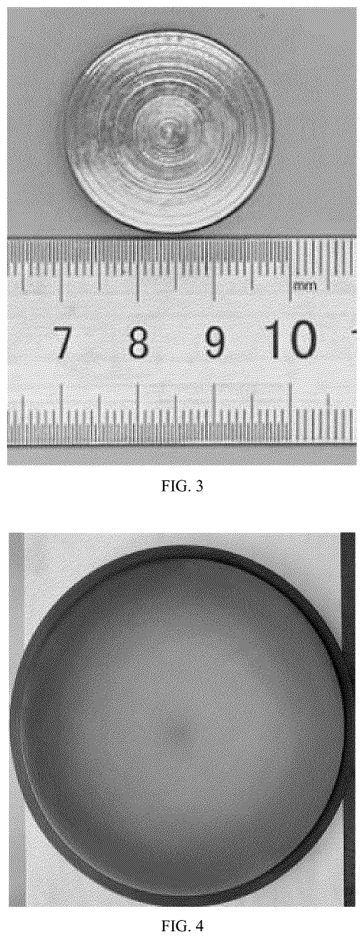

A top view of the high-purity copper condensate product prepared through the vacuum distillation is shown in FIG. 3.

After test, it can be found that the high-purity copper condensate obtained through the vacuum distillation has a mass of 7.428 g, a recovery rate of 70.34%, and a purity of 99.9991%.

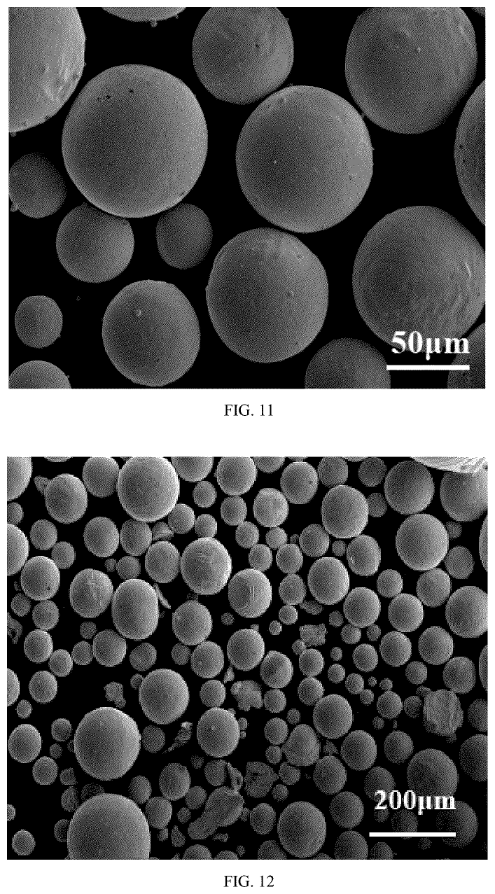

For a high-purity copper particle volatile obtained through the vacuum distillation, namely, the high-purity copper particles, a top view is shown in FIG. 4 and an SEM image is shown in FIG. 11. It can be seen from FIG. 11 that the high-purity copper particles obtained in the present disclosure have a smooth surface and a regular shape.

After test, it can be found that the high-purity copper particles have a mass of 3.132 g, and a yield of 29.66%. The high-purity copper particles have a particle size of 1 μm to 10 μm, and a purity of 99.9991%.

### Example 2

(1) 10.24 g of 3 N-grade electrolytic cathode copper was cleaned with absolute ethanol, and then air-dried naturally in a clean room, and then added into a vacuum distillation furnace. The vacuum distillation furnace was vacuumed to maintain a gas pressure in the vacuum distillation furnace at 10 Pa. The electrolytic cathode copper was heated uniformly to 1,450° C. at a heating rate of 10° C./min, and then subjected to vacuum distillation for 100 min such that volatile impurity elements such as Al, Cd, Bi, Ga, K, Mg, Zn, Pb, Ga, Fe, Ni, Si, and Au volatilized to a lower surface of the evaporation orifice plate. Then, the vacuum distillation furnace was cooled with circulation water under vacuum to ambient temperature, such that a high-purity copper condensate was obtained in a crucible and high-purity copper particles were collected on the condensation plate.

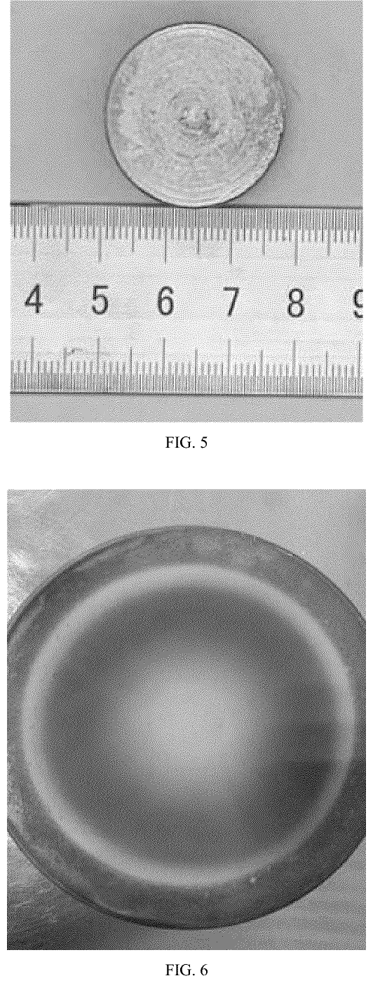

A top view of the high-purity copper condensate prepared through vacuum distillation is shown in FIG. 5.

After test, it can be found that the high-purity copper condensate obtained through the vacuum distillation has a mass of 8.046 g, a recovery rate of 78.57%, and a purity of 99.9992%.

A top view of the high-purity copper particle volatile prepared through the vacuum distillation is shown in FIG. 6.

After test, it can be found that the high-purity copper particles have a mass of 2.194 g, and a yield of 21.43%. The high-purity copper particles have a particle size of 1 μm to 10 μm, and a purity of 99.9987%.

### Example 3

(1) 10.54 g of 3 N-grade electrolytic cathode copper was cleaned with absolute ethanol, then air-dried naturally in a clean room, and then added into a vacuum distillation furnace. The vacuum distillation furnace was vacuumed to maintain a gas pressure in the vacuum distillation furnace at 5 Pa. The electrolytic cathode copper was heated uniformly to 1,500° C. at a heating rate of 10° C./min, and then subjected to vacuum distillation for 90 min such that volatile impurity elements such as Al, Cd, Bi, Ga, K, Mg, Zn, Pb, Ga, Fe, Ni, Si, and Au volatilized to a lower surface of the evaporation orifice plate. Then, the vacuum distillation furnace was cooled with circulation water under vacuum to ambient temperature, such that a high-purity copper condensate was obtained in a crucible and high-purity copper particles were collected on the condensation plate.

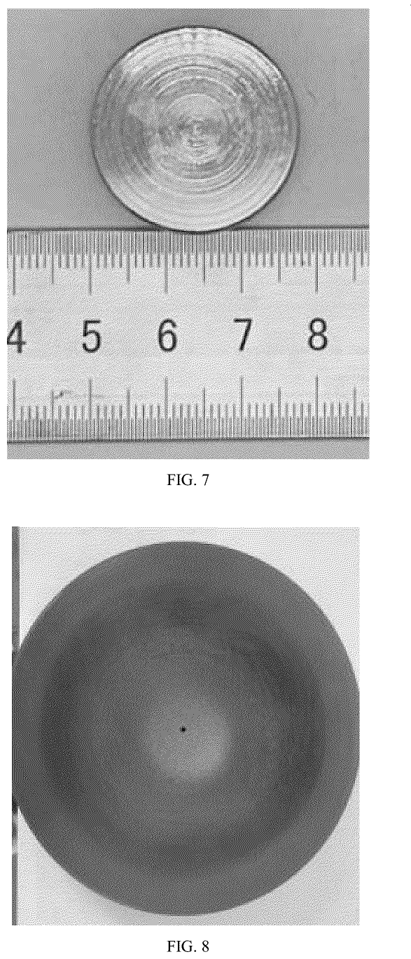

A top view of the high-purity copper condensate prepared through the vacuum distillation is shown in FIG. 7.

After test, it can be found that the high-purity copper condensate obtained through the vacuum distillation has a mass of 7.783 g, a recovery rate of 73.84%, and a purity of 99.9987%.

For a high-purity copper volatile obtained through the vacuum distillation, namely, the high-purity copper particles, a top view is shown in FIG. 8 and an SEM image is shown in FIG. 12. It can be seen from FIG. 12 that the copper powder particles have non-uniform particle sizes, and include some non-spherical small particles. In combination with the characterization results of Example 1 (FIG. 11), it can be seen that a holding time has a great impact on a sphere-forming rate of the copper powder particles, and within a specified holding time range, the longer the holding time, the higher the sphere-forming rate and the more uniform the particle sizes of the copper powder particles.

After test, it can be found that the high-purity copper particles have a mass of 2.757 g, and a yield of 26.16%. The high-purity copper particles have a particle size of 1 μm to 10 μm, and a purity of 99.99902%.

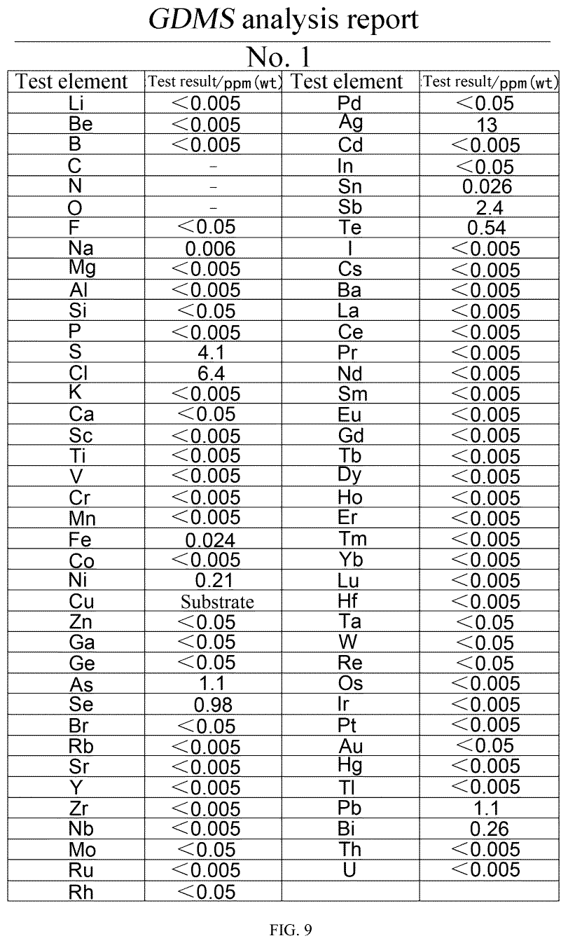

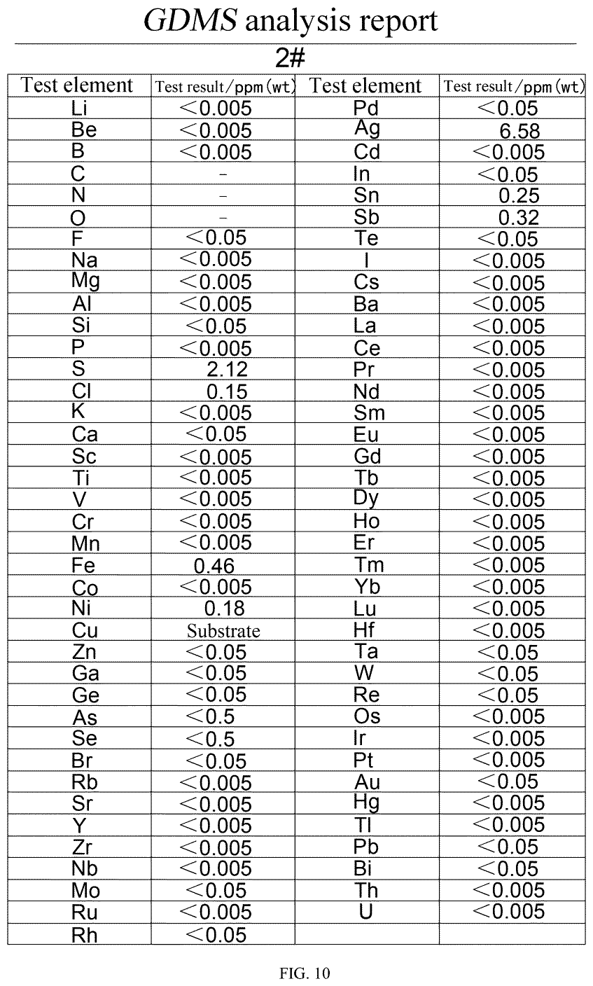

Test results of the high-purity copper condensate obtained through vacuum distillation are shown in FIG. 9, and a test report of the volatile (namely, the high-purity copper particles) is shown in FIG. 10.

### Examples 4 to 11

These examples were performed according to Example 1 except for vacuum distillation conditions, and specific vacuum distillation conditions and purities of high-purity copper particles were shown in Table 1.

TABLE 1
Vacuum distillation conditions and purities of high-
purity copper particles in Examples 4 to 11

| | | Vacuum | | |
|---|---|---|---|---|
| Example No. | Temperature/° C. | degree/Pa | Time/h | Purity/% |
| Example 4 | 1400 | 5 | 1 | 99.998990 |
| Example 5 | 1400 | 5 | 1.5 | 99.999151 |
| Example 6 | 1400 | 5 | 2 | 99.999302 |
| Example 7 | 1450 | 5 | 1.5 | 99.999069 |
| Example 8 | 1450 | 5 | 2 | 99.998015 |
| Example 9 | 1500 | 10 | 1.5 | 99.999101 |
| Example 10 | 1500 | 10 | 1.5 | 99.999202 |
| Example 11 | 1500 | 10 | 1.5 | 99.999300 |

The above are merely preferred embodiments of the present disclosure. It should be noted that several improvements and modifications could further be made by those skilled in the art without departing from the principle of the present disclosure, and such improvements and modifications should also be deemed as falling within the scope of the present disclosure.

1. A vacuum distillation furnace, wherein an evaporation orifice plate is provided between a condensation plate and an evaporation chamber; and the evaporation orifice plate has a pore size of 1 mm to 10 mm.

2. The vacuum distillation furnace of claim 1, wherein the evaporation orifice plate has a porosity of 0.138% to 13.80%.

3. The vacuum distillation furnace of claim 1, wherein the evaporation orifice plate has a shape of a conical disc; and a vertex of the conical disc is above a bottom surface of the conical disc.

4. The vacuum distillation furnace of claim 3, wherein a vertical distance between a lowest point and a highest point of the evaporation orifice plate is in a range of 5 cm to 10 cm.

5. The vacuum distillation furnace of claim 3, wherein the highest point of the evaporation orifice plate is located at ½ of a zone between the evaporation chamber and the condensation plate.

6. The vacuum distillation furnace of claim 1, wherein the evaporation orifice plate is a chromium plate.

7. The vacuum distillation furnace of claim 1, wherein volatilization pores in the evaporation orifice plate are sequentially distributed in a number of 1², 2², 3², 4², 5² . . . n² from a center of the evaporation orifice plate to an edge of the evaporation orifice plate.

8. A method for preparing high-purity copper particles, comprising:
adding a metallic copper raw material into the evaporation chamber of the vacuum distillation furnace of claim 1; and
subjecting the metallic copper raw material to vacuum distillation to obtain the high-purity copper particles on the condensation plate;
wherein the vacuum distillation is conducted at a vacuum degree of 0.1 Pa to 100 Pa and a temperature of 1,100° C. to 1,800° C.; and
the high-purity copper particles have a particle size of 1 μm to 100 μm.

9. The method of claim 8, wherein the vacuum distillation is conducted for 0.5 h to 3 h.

10. The method of claim 8, wherein the metallic copper raw material is heated to the temperature for the vacuum distillation at a heating rate of 5° C./min to 20° C./min.

11. The method of claim 8, wherein the metallic copper raw material comprises an electrolytic cathode copper.

12. The method of claim 8, wherein the particle size of the high-purity copper particles is in a range of 1 μm to 10 μm.

13. The vacuum distillation furnace of claim 4, wherein the highest point of the evaporation orifice plate is located at ½ of a zone between the evaporation chamber and the condensation plate.

14. The vacuum distillation furnace of claim 2, wherein the evaporation orifice plate is a chromium plate.

15. The vacuum distillation furnace of claim 3, wherein the evaporation orifice plate is a chromium plate.

16. The vacuum distillation furnace of claim 3, wherein volatilization pores in the evaporation orifice plate are sequentially distributed in a number of 1², 2², 3², 4², 5² . . . n² from a center of the evaporation orifice plate to an edge of the evaporation orifice plate.

17. The method of claim 8, wherein the evaporation orifice plate has a porosity of 0.138% to 13.80%.

18. The method of claim 8, wherein the evaporation orifice plate has a shape of a conical disc; and a vertex of the conical disc is above a bottom surface of the conical disc.

19. The method of claim 18, wherein a vertical distance between a lowest point and a highest point of the evaporation orifice plate is in a range of 5 cm to 10 cm.

20. The method of claim 9, wherein the metallic copper raw material is heated to the temperature for the vacuum distillation at a heating rate of 5° C./min to 20° C./min.
